(19) United States
(12) Patent Application Publication
(10) Pub. No.: US 2012/0285608 A1
(43) Pub. Date: Nov. 15, 2012

(54) METHOD FOR PRODUCING LIQUID CRYSTAL PANEL

(75) Inventor: Chikanori Tsukamura, Osaka-shi (JP)

(73) Assignee: Sharp Kabushiki Kaisha, Osaka (JP)

(21) Appl. No.: 13/519,276

(22) PCT Filed: Nov. 8, 2010
(86) PCT No.: PCT/JP2010/069781

§ 371 Date: Jun. 26, 2012

(30) Foreign Application Priority Data
Dec. 28, 2009 (JP) 2009 297663

(51) Int. Cl. B32B 37/14; B29C 65/00

(52) U.S. Cl. 156/145; 264/1.7

(57) ABSTRACT

A method for producing a liquid crystal panel which can prevent a pair of substrates from being bent and can uniformize the cell thickness is provided. According to the method for producing the liquid crystal panel, a black matrix (BM) 24 is formed in one of a pair of prepared substrates 11 and 12, in a peripheral area outer to an area where a liquid crystal layer 13 is to be formed. A panel sealing material which is to form a panel sealing portion 20 is provided so as to overlap at least a part of the BM. An assisting sealing material which is to form an assisting sealing portion 40 is provided on either one of the pair of substrates. The pair of substrates are brought together. A bending prevention member 36 is provided in a part where the assisting sealing portion is formed and/or a part between the assisting sealing portion and the panel sealing portion, in order to prevent the pair of substrates from being bent between the panel sealing portion and the assisting sealing portion.

### REFERENCE TO RELATED APPLICATIONS

This application is a national stage application under 35 USC 371 of International Application No. PCT/JP2010/069781, filed Nov. 8, 2010, which claims priority from Japanese Patent Application No. 2009-297663, filed Dec. 28, 2009, the entire contents of which are incorporated herein by reference.

### FIELD OF THE INVENTION

The present invention relates to a technology for producing a liquid crystal panel usable as, for example, a liquid crystal display panel in a liquid crystal display device.

### BACKGROUND OF THE INVENTION

Liquid crystal display devices including a liquid crystal display panel (liquid crystal panel) are widely used as image display devices (displays) of TV, personal computers and the like.

Such a liquid crystal panel includes a pair of substrates facing each other (typically, an array substrate and a color filter substrate located to face the array substrate) while a prescribed space (gap) is guaranteed therebetween via a sealing member. Between the pair of substrates, a liquid crystal material is sealed and is held in the form of a liquid crystal layer.

A rectangular active area (effective display area, namely, a display screen area; hereinafter, may be referred to simply as a “display area”) defined in the gap between the pair of substrates included in the liquid crystal panel (typically, an array substrate and a color filter substrate) is filled with a liquid crystal material (i.e., the liquid crystal material is injected into the active area), and thus the liquid crystal layer is formed. In order to distinguish the area which is filled with the liquid crystal material from an area which is not filled with the liquid crystal material (i.e., outside the display area), a sealing material (panel sealing material) is provided in an annular shape so as to surround the display area.

Methods for filling the display area with the liquid crystal material include a dip method of filling the display area with the liquid crystal material by use of the capillary phenomenon, a dispenser method of dripping the liquid crystal material into the display area, and the like.

Around the sealing material provided in an annular shape, an outer peripheral sealing material or the like may be provided in order to prevent the pair of substrates from being shifted from each other when the substrates are brought together. Such sealing materials (including the panel sealing material and the outer peripheral sealing material) contain spacers for maintaining the gap between the substrates at a certain distance. Prior art regarding this type of technology is described in Patent Documents 1 and 2.

### PATENT DOCUMENT

Patent Document 1: Japanese Patent Laid-Open Publication No. 2005-227696

Patent Document 2: Japanese Patent Laid-Open Publication No. 2006-171682

### SUMMARY OF THE INVENTION

Bringing together a pair of substrates by use of such double-structured sealing materials involves the following problem. When a sealing portion formed of the panel sealing material (hereinafter, referred to as a “panel sealing portion”) and a sealing portion formed of the outer peripheral sealing material (hereinafter, referred to as an “assisting sealing portion”) have different heights from surfaces of the pair of substrates, the substrates may be bent when being brought together and a cell thickness may become non-uniform. Especially when the panel sealing portion is stacked on at least a part of a black matrix formed so as to surround a display area of a color filter substrate (hereinafter, referred to as a “CF substrate”), a part of the panel sealing portion which is located on the black matrix and a part of the panel sealing portion which is not located on the black matrix have different compression ratios. For this and other reasons, the substrates are bent in the vicinity of the black matrix, and thus the cell thickness easily becomes non-uniform, which is not preferable. More specifically, a defect such as a light leak (typically, light from a backlight unit leaks outside via the panel) may occur in a part having a larger cell thickness than the remaining part.

The present invention made to solve the above-described problem has an object of preventing the pair of substrates from being bent during a liquid crystal panel production process to provide a liquid crystal panel having an entirely uniform cell thickness, and of providing a technology for producing such a panel.

In order to achieve the above-described object, the present invention provides a method for producing a liquid crystal panel which includes a pair of substrates facing each other; a liquid crystal layer formed between the pair of substrates; and a panel sealing portion located around the liquid crystal layer between the pair of substrates so as to surround the liquid crystal layer to hold the liquid crystal layer between the pair of substrates. The production method disclosed herein includes the following steps (1) through (3): (1) preparing a first substrate and a second substrate acting as the pair of substrates, wherein a black matrix (hereinafter, referred to also as a “BM”), for blocking external light from entering an area where the liquid crystal layer is to be formed, is formed at a surface of the first substrate facing the liquid crystal layer, in a peripheral area outer to the area where the liquid crystal layer is to be formed; a panel sealing material which is to form the panel sealing portion is provided so as to overlap at least a part of the black matrix; and an assisting sealing material which is to form an assisting sealing portion is provided on either the first substrate or the second substrate, at a position which is away from the black matrix in an outer direction by a predetermined distance; (2) bringing together the first substrate and the second substrate to form the panel sealing portion formed of the panel sealing material and the assisting sealing portion formed of the assisting sealing material; and (3) supplying a liquid crystal material before or after bringing together the first substrate and the second substrate to form the liquid crystal layer between the pair of substrates. A bending prevention member for preventing bending is provided in a part where the assisting sealing portion is formed and/or a part between the assisting sealing portion and the panel sealing portion, in order to prevent the pair of substrates from being bent between the panel sealing portion and the assisting sealing portion when the pair of substrates are brought together.

According to the method for producing the liquid crystal panel provided by the present invention, a bending prevention member (gap holding member) for preventing bending is provided in a part where the assisting sealing portion (assisting sealing material) is formed and/or a part between the assisting sealing portion and the panel sealing portion (panel sealing material), in order to prevent the pair of substrates from being bent between the panel sealing portion and the assisting sealing portion (i.e., in order to maintain the interval between the substrates at a certain distance).

Owing to this, when the first substrate and the second substrate are brought together, the space (gap) from the surface of the first substrate to a surface of the second substrate in the part where the black matrix and the panel sealing portion are stacked (hereinafter, referred to also as a “panel sealing portion stacking part”) is equal to the surface of the first substrate to the surface of the second substrate in the part where the assisting sealing portion is formed (hereinafter, referred to also as an “assisting sealing portion formation part”). In addition, the gap from the surface of the first substrate to the surface of the second substrate can also be made uniform in the area from the panel sealing portion stacking part to the assisting sealing portion formation part. Therefore, neither substrate is bent and as a result, the cell thickness can be prevented from becoming non-uniform.

Therefore, according to the present invention, a method for producing a liquid crystal panel which can prevent a pair of substrates from being bent and can uniformize the cell thickness is provided.

In a preferable embodiment of the production method disclosed herein, the panel sealing material and the assisting sealing material each include granular spacers for holding a gap between the pair of substrates. The spacers in the assisting sealing material are contained as the bending prevention member and have a larger grain diameter than that of the spacers contained in the panel sealing material.

According to such a production method, spacers having different grain diameters are used. Owing to this, the gap between the substrates at the panel sealing portion stacking part can be easily made equal to the gap between the substrates at the assisting sealing portion formation part, and also the gap from the surface of the first substrate to the surface of the second substrate can be made uniform in the area from the panel sealing portion stacking part to the assisting sealing portion formation part. Therefore, neither substrate is bent and as a result, the cell thickness can be made uniform.

In a preferable embodiment of the production method disclosed herein, in the part where the assisting sealing portion is formed, a base part, on which the assisting sealing material which is to form the assisting sealing portion is stacked, is formed as the bending prevention member in either one of the pair of substrates, and the assisting sealing portion is formed in state of being stacked on the base part.

According to such a production method, the assisting sealing portion is formed in state of being stacked on the base part. Owing to this, the gap between the substrates at the panel sealing portion stacking part can be easily made equal to the gap between the substrates at the assisting sealing portion formation part, and also the gap from the surface of the first substrate to the surface of the second substrate can be made uniform in the area from the panel sealing portion stacking part to the assisting sealing portion formation part. Therefore, neither substrate is bent and as a result, the cell thickness can be made uniform.

In a preferable embodiment of the production method disclosed herein, the base part is formed by use of at least one of a black matrix formation material, a colored layer formation material, and a photospacer formation material.

According to such a production method, the base part can be formed in the step of producing the substrates. Therefore, it is not necessary to add a new step, which is preferable.

In a preferable embodiment of the production method disclosed herein, in the part between the panel sealing portion and the assisting sealing portion, a column-like member for holding the gap between the substrates in the part is formed as the bending prevention member.

According to such a production method, a column-like member is formed in the part between the panel sealing portion stacking part and the assisting sealing portion formation part. Owing to this, the gap from the surface of the first substrate to the surface of the second substrate can be made uniform in the area from the panel sealing portion stacking part to the assisting sealing portion formation part. Therefore, neither substrate is bent and as a result, the cell thickness can be made uniform.

In a preferable embodiment of the production method disclosed herein, the column-like member is formed by use of at least one of a black matrix formation material, a colored layer formation material, and a photospacer formation material.

According to such a production method, the column-like member can be formed in the step of producing the substrates. Therefore, it is not necessary to add a new step, which is preferable.

In another aspect, the present invention provides a method for producing a liquid crystal display device. The method is for producing a liquid crystal display device in which a liquid crystal panel is held by a predetermined frame member, the liquid crystal panel including a pair of substrates facing each other, a liquid crystal layer formed between the pair of substrates, and a panel sealing portion located around the liquid crystal layer between the pair of substrates so as to surround the liquid crystal layer to hold the liquid crystal layer between the pair of substrates. Such a method comprises any method for producing a liquid crystal panel disclosed herein as a process for producing the liquid crystal panel.

As described above, a liquid crystal panel produced by any method for producing a liquid crystal panel disclosed herein prevents the pair of substrates from being bent and maintains the cell thickness uniform. Accordingly, a liquid crystal display device including such a liquid crystal panel has a superb display quality.

### BRIEF DESCRIPTION OF THE DRAWINGS

FIG. 1 is a cross-sectional view schematically showing a structure of a liquid crystal display device in an embodiment according to the present invention.

FIG. 2 is a plan view schematically showing one important part of a liquid crystal panel in the embodiment according to the present invention.

FIG. 3 is a cross-sectional view taken along line in FIG. 2 and schematically shows a structure of the liquid crystal panel.

FIG. 4 is a cross-sectional view taken along line IV-IV in FIG. 2 and schematically shows a peripheral area of the liquid crystal panel.

FIG. 5 is a flowchart showing a method for producing a liquid crystal panel in the embodiment according to the present invention.

FIG. 6 is a cross-sectional view schematically showing a structure of an array substrate in the embodiment according to the present invention.

FIG. 7 is a cross-sectional view schematically showing a structure of a CF substrate in the embodiment according to the present invention.

FIG. 8 is a cross-sectional view schematically showing the CF substrate in the embodiment according to the present invention, provided with a sealing material at a predetermined position.

FIG. 9 is a cross-sectional view schematically showing the array substrate and the CF substrate in the embodiment according to the present invention, which are brought together such that display areas thereof face each other.

FIG. 10 is a cross-sectional view schematically showing a structure of the liquid crystal panel in the embodiment according to the present invention, after a cutting step.

FIG. 11 is a cross-sectional view schematically showing a structure of a CF substrate in another embodiment according to the present invention.

FIG. 12 is a cross-sectional view schematically showing the CF substrate in the another embodiment according to the present invention, provided with a sealing material at a predetermined position.

FIG. 13 is a cross-sectional view schematically showing an array substrate and the CF substrate in the another embodiment according to the present invention, which are brought together such that display areas thereof face each other.

FIG. 14 is a cross-sectional view schematically showing a structure of a CF substrate in still another embodiment according to the present invention.

FIG. 15 is a cross-sectional view schematically showing the CF substrate in the still another embodiment according to the present invention, provided with a sealing material at a predetermined position.

FIG. 16 is a cross-sectional view schematically showing an array substrate and the CF substrate in the still another embodiment according to the present invention, which are brought together such that display areas thereof face each other.

### DETAILED DESCRIPTION OF THE INVENTION

Hereinafter, preferable embodiments of the present invention will be described with reference to the drawings. Elements which are other than elements specifically referred to in this specification and are necessary to carry out the present invention may be grasped as a matter of design choice for a person of ordinary skill in the art based on the conventional art. The present invention can be carried out based on the contents disclosed by this specification and the attached drawings and the technological common knowledge in the art.

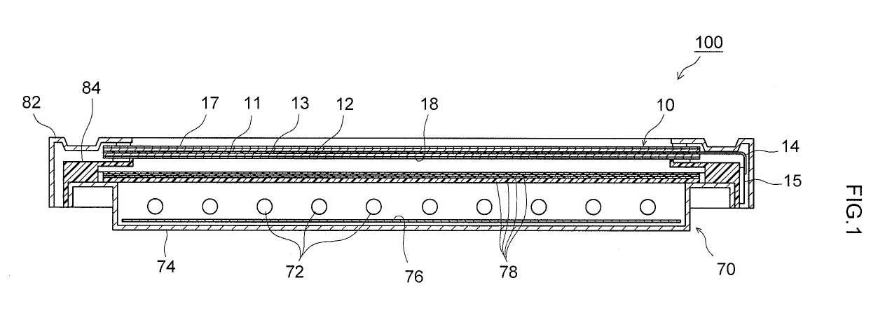

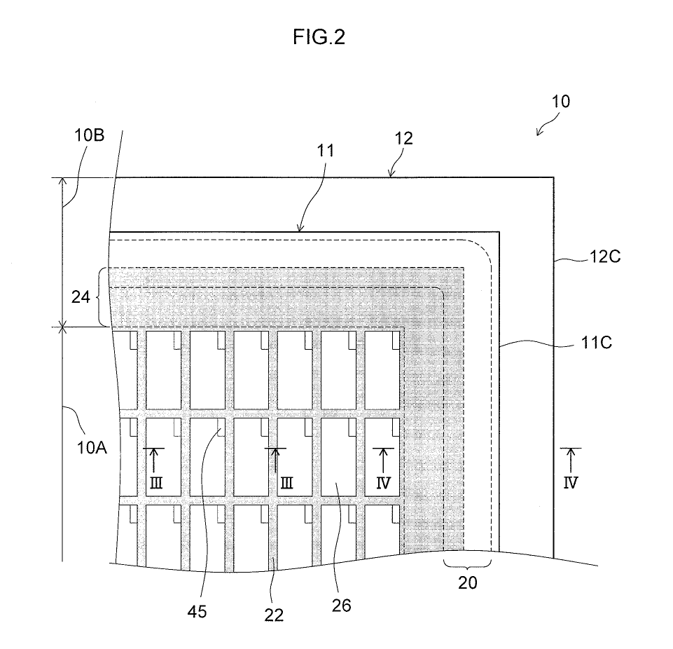

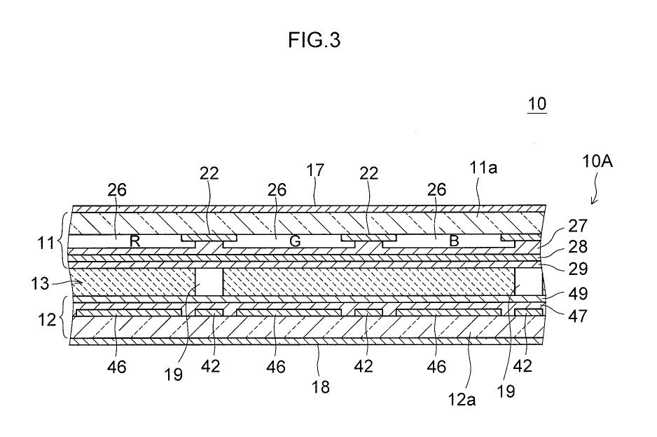

With reference to FIG. 1 through FIG. 3, a liquid crystal panel 10 obtained by a production method according to a preferable embodiment of the present invention (Embodiment 1) and a liquid crystal display device 100 including the liquid crystal panel 10 will be described. FIG. 1 is a cross-sectional view, schematically showing a structure of the liquid crystal display device 100 in this embodiment. FIG. 2 is a cross-sectional view schematically showing one important part of the liquid crystal panel 10 in this embodiment. FIG. 3 is a cross-sectional view taken along line in FIG. 2 and schematically shows a structure of the liquid crystal panel 10 (display area 10A).

In the figures referred to below, members or portions having the same functions bear the same reference characters and descriptions thereof may not be repeated or may be simplified. In the figures, the relative sizes (length, width, thickness, etc.) do not necessarily reflect the actual relative sizes accurately. In the following description, the “top side” or “front side” means the side of the liquid crystal display device 100 facing the viewer (i.e., the liquid crystal panel side), and the “bottom side” or “rear side” means the side of the liquid crystal display device 100 not facing the viewer (i.e., the backlight unit 70 side).

With reference to FIG. 1, an overall structure of the liquid crystal display device 100 will be described. As shown in FIG. 1, the liquid crystal display device 100 includes the liquid crystal panel 10 and a backlight unit 70 which is an external light source located on the rear side of the liquid crystal panel 10. The liquid crystal panel 10 and the backlight unit 70 are assembled together by a bezel (frame member) 82 or the like and thus are integrally held.

With reference to FIG. 2 and FIG. 3, a structure of the liquid crystal panel 10 will be described.

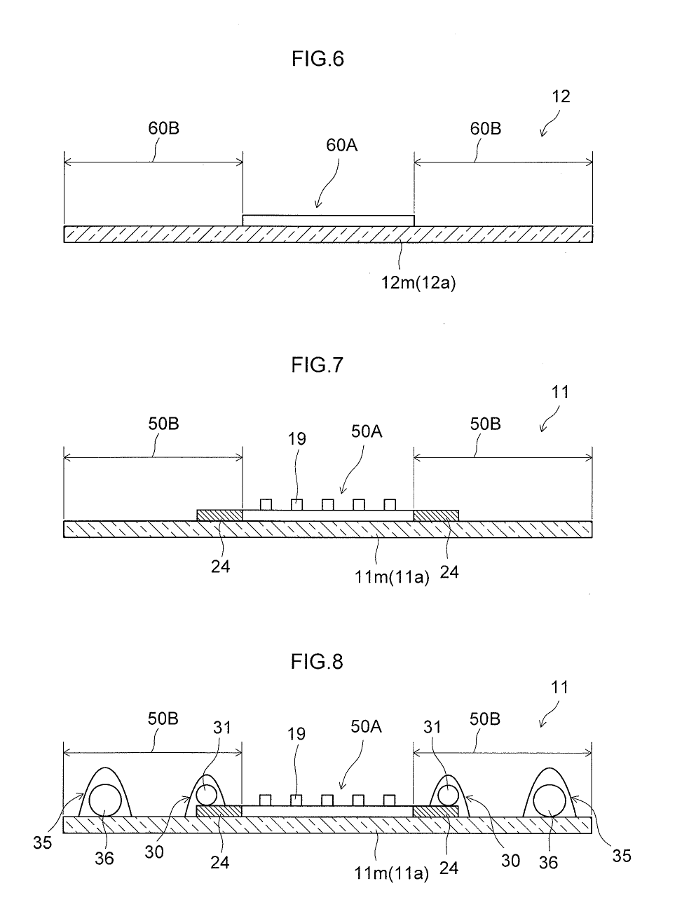

The liquid crystal panel 10 has a generally rectangular overall shape. As shown in FIG. 2, the liquid crystal panel 10 includes the display area 10A which is an area (typically, of a rectangular shape) having pixels formed in a central part thereof and provided for displaying an image to the viewer (i.e., a CF substrate-side display area 50A (see FIG. 7) and an array substrate-side display area 60A (see FIG. 6); these display areas are collectively referred to as the “display area 10A”), and a non-display area 10B which is an area (typically, of a frame-like shape) formed in a peripheral area outer to the display area 10A so as to surround the display area 10A (i.e., a CF substrate-side non-display area 50B (see FIG. 7) and an array substrate-side non-display area 60B (see FIG. 6); these non-display areas are collectively referred to as the “non-display area 10B”).

As shown in FIG. 3, the liquid crystal panel 10 has a sandwich structure including a pair of light-transmissive glass substrates 11 and 12 facing each other and a liquid crystal layer 13 provided therebetween. The liquid crystal layer 13 has a liquid crystal material sealed therein. Among the pair of light-transmissive glass substrates 11 and 12, the substrate located on the front side is the color filter substrate (CF substrate) 11, and the substrate located on the rear side is the array substrate (TFT substrate) 12.

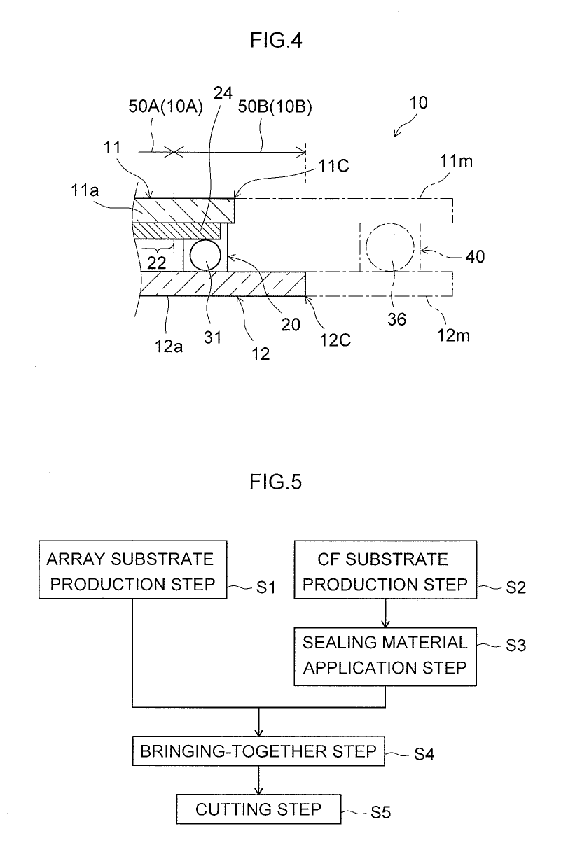

A panel sealing portion 20 for sealing the liquid crystal layer 13 is formed in the non-display area 10B of the peripheral area of the CF substrate 11 and the array substrate 12. The panel sealing portion 20 is provided so as to surround the display area 10A. The panel sealing portion 20 is in direct contact with the CF substrate 11 and the array substrate 12 (see FIG. 4).

At least a part of the panel sealing portion 20 overlaps a frame black matrix 24 (described later) formed on the CF substrate 11 (see FIG. 4). The liquid crystal layer 13 is formed of the liquid crystal material containing liquid crystal molecules. When a voltage is applied between the CF substrate 11 and the array substrate 12, an alignment of the liquid crystal molecules in the liquid crystal material is controlled and thus the optical characteristics of the liquid crystal molecules are changed. At surfaces of the CF substrate 11 and the array substrate 12 facing each other (surfaces facing the liquid crystal layer 13), alignment films 29 and 49 for determining the alignment direction of the liquid crystal molecules are respectively formed.

Now, the CF substrate 11 and the array substrate 12 of the liquid crystal panel 10 disclosed by this application will be described in more detail. The CF substrate 11 and the array substrate 12 have substantially the same structures as those of a CF substrate and an array substrate of a general liquid crystal panel, and include the display area 10A and the non-display area 10B. First, the CF substrate-side display area 50A (see FIG. 10) of the CF substrate 11 and the array substrate-side display area 60A (see FIG. 10) of the array substrate 12 will be each described.

On the front side of a glass substrate main body 12a included in the array substrate 12 (on the side facing the liquid crystal layer 13), pixels (more precisely, sub pixels) for displaying an image are arrayed in the array substrate-side display area 60A, and a plurality of gate lines (scanning lines; not shown) and source lines (signal lines) 42, both of which are for driving the pixels, are formed in a lattice pattern. On the substrate main body 12a, storage capacitance lines (also referred to as an “accumulated capacitance lines” or “Cs lines”) are provided independently from, and parallel to, the gate lines.

In each of lattice areas enclosed by the gate lines and the source lines 42, a pixel electrode 46 and a thin film transistor (TFT) 45 as a switching element are provided. In addition, a storage capacitance (also referred to as an “accumulated storage capacitance” or “Cs”; not shown) for stabilizing the potential of the pixel electrode 46 is formed. The pixel electrode 46 is typically formed of ITO (indium tin oxide), which is a transparent conductive material, and is electrically connected to a drain electrode of the TFT 45. The pixel electrode 46 is supplied with a voltage in accordance with the image at a predetermined timing via the corresponding gate line, the corresponding source line 42 and the corresponding TFT 45. In each lattice area, a storage capacitance electrode (also referred to as an “accumulated capacitance electrode” or a “Cs electrode”) is formed. The storage capacitance is formed by the storage capacitance electrode and the pixel electrode 46.

As shown in FIG. 1, along at least one side of the peripheral area of the rectangular array substrate 12, a plurality of flexible boards (TCPs) 14 are located side by side. On each of the flexible boards 14, a liquid crystal panel driving IC chip (driver IC chip; not shown) for driving the liquid crystal panel 10 is mounted. The driver IC chip is connected to the corresponding source line 42 and the corresponding gate line. At a tip of each flexible board 14, a connection board 15 is attached. The connection board 15 has a controller for controlling the driver IC (chip), other electronic components and the like incorporated thereto. The connection board 15 is also referred to as a “printed circuit board (PCB)”. Since the flexible board 14 is folded to the backlight unit 70 side, the connection board 15 is located on a side surface of the backlight unit 70 (more precisely, the outer side surface of a frame 84) or on the rear side of the backlight unit 70. The pixel electrodes 46, the source lines 42 and the gate lines are covered with a flattening layer (also referred to as an “interlayer insulating film”) 47 formed of an insulating material. On the flattening layer 47, the alignment film 49 is formed as described above. A surface of the alignment film 49 has been subjected to an alignment treatment in order to determine the alignment direction of the liquid crystal molecules in the absence of a voltage. The alignment treatment may be, for example, a rubbing treatment, an optical alignment treatment or the like.

As shown in FIG. 3, on the rear side of a glass substrate main body 11a included in the CF substrate 11 (on the side facing the liquid crystal layer 13), color filters (colored layers) 26 are formed in positional correspondence with the pixel electrodes 46 of the array substrate 12, and a black matrix (light blocking film) 22 is formed for partitioning the filters 26 of different colors (and thus for preventing light from leaking through an area between the pixels to improve the contrast and to prevent mixing of the colors). As shown in FIG. 3, the color filters 26 are of three colors of red (R), green (G) and blue (B). The color filter 26 of one of the colors of R, G and B faces each pixel electrode 46 of the array substrate 12. The black matrix 22 is formed of a metal material such as Cr (chromium) or the like in order to prevent light from being transmitted through areas between the sub pixels.

As shown in FIG. 3, a flattening layer 27 is formed so as to cover the color filters 26 and the black matrix 22. On a surface of the flattening layer 27, a transparent electrode (common electrode) 28 formed of ITO is formed. On a surface of the transparent electrode 28, the alignment film 29 is formed. A surface of the alignment film 29 has also been subjected to an alignment treatment. The alignment direction of the alignment film 49 of the array substrate 12 and the alignment direction of the alignment film 29 of the CF substrate 11 are different from each other by 90°.

As shown in FIG. 3, in the space (gap) between the CF substrate 11 and the array substrate 12, a plurality of cylindrical photospacers 19 are located in a dispersed manner. The photospacers 19 are formed of, for example, an elastically deformable resin material. Owing to this, the gap (space) between the substrates 11 and 12 is held by the panel sealing portion 20 (panel spacers 31 in the panel sealing portion (see FIG. 4)) and the photospacers 19, and thus the liquid crystal layer 13 is maintained at a certain thickness. The photospacers 19 may be formed at predetermined positions by photolithography. The spacers for holding the gap between the substrates 11 and 12 may be spherical. In this case, the spacers may be located (scattered) on the substrates by use of an inkjet device or the like.

Typically, on surfaces of the substrates 11 and 12 which do not face each other, polarizing plates (polarizing sheets) are provided. In this embodiment, as shown in FIG. 3, polarizing plates 17 and 18 are attached to the substrate main bodies 11a and 12a respectively. In a so-called normally white type liquid crystal display device, the two polarizing plates 17 and 18 are located such that polarization axes thereof are perpendicular to each other. In a so-called normally black type liquid crystal display device, the two polarizing plates 17 and 18 are located such that polarization axes thereof are parallel to each other.

The structure of the pixels, the structure of the electrodes and the lines, the driving circuits and the like described above may be substantially the same as those of a conventional liquid crystal panel and do not characterize the present invention, and thus will not be described in further detail.

Now, a structure of the non-display area 10B of the liquid crystal panel 10 will be described with reference to FIG. 4. FIG. 4 is a cross-sectional view taken along line IV-IV in FIG. 2, and schematically shows the peripheral area of the liquid crystal panel 10. In FIG. 4, the elements on the CF substrate 11 (substrate main body 11a) other than the black matrix 22 and the frame black matrix 24 (e.g., the flattening layer 27, the transparent electrode 28, the alignment film 29, etc.) are not shown for the sake of simplicity. Similarly, the elements on the array substrate 12 (substrate main body 12a), for example, the pixel electrode 46, the metal lines (source lines 42 and the gate lines), the flattening layer 47 and the like are not shown for the sake of simplicity.

As shown in FIG. 2 and FIG. 4, in the CF substrate-side non-display area 50B on the CF substrate 11 (substrate main body 11a) (i.e., on the side of the CF substrate 11 facing the array substrate 12 and adjacent to the liquid crystal layer 13), the frame black matrix 24 is formed so as to surround the CF substrate-side display area 50A. The frame black matrix 24 is formed in a frame-like shape which surrounds the outer periphery of the CF substrate-side display area 50A, in order to block external light which would otherwise enter the CF substrate-side display area 50A (e.g., light which may leak from the backlight unit 70). Typically, the frame black matrix 24 is formed integrally with, and continuously to, the black matrix 22 provided for partitioning the color filters 26 formed in the CF substrate-side display area 50A.

In the non-display area 10B of the liquid crystal panel 10, the panel sealing portion 20 for sealing the liquid crystal layer 13 held between the two substrates 11 and 12 of the liquid crystal panel 10 is formed in direct contact with (typically, formed to be bonded with) the substrates 11 and 12. At least a part of the panel sealing portion 20 is formed to overlap (typically, to be stacked on) the frame black matrix 24 formed on the CF substrate 11. As shown in FIG. 4, the panel sealing portion 20 includes the spherical or cylindrical panel spacers 31 (spherical in FIG. 4), which maintain the space (gap) between the substrates 11 and 12 at a prescribed distance.

The panel sealing portion 20 may be preferably formed by use of a sealing material formed of a material which is preferably bonded to the CF substrate 11 and the array substrate 12 and can prevent flow of the liquid crystal material from the liquid crystal layer 13 for a long period of time. As such a material, any material usable for a sealing portion of a general liquid crystal panel is usable with no specific limitation. For example, a thermosetting resin material or a photocurable resin material is usable. A photocurable resin material, typically, a UV-curable resin material is preferably usable.

In the liquid crystal display device 100 including the above-described liquid crystal panel 10, on the front side of the liquid crystal panel 10, the bezel (frame member) 82 is mounted as shown in FIG. 1. On the rear side of the liquid crystal panel 10, the frame 84 (frame member) is mounted. The bezel 82 and the frame 84 support the liquid crystal panel 10 while holding both surfaces of the liquid crystal panel 10. An area of the frame 84 corresponding to the display area 10A of the liquid crystal panel 10 is opened. On the rear side of the liquid crystal panel 10, the backlight unit 70 accommodated in a case 74 is mounted.

As shown in FIG. 1, the backlight device 70 includes a plurality of linear light sources (typically, cold-cathode fluorescent tubes, light emitting diodes, etc.) 72 and the case (chassis) 74 for accommodating the light sources 72. The case 74 has a box-like shape which is opened toward the front side. In the case 74, the light sources 72 are located, typically, parallel to each other. Between the case 74 and the light sources 72, a reflective member 76 for efficiently reflecting light from the light sources 72 toward the viewer is located.

In the opening of the case 74, a plurality of sheet-like optical members 78 are stacked and located so as to cover the opening. The optical members 78 are, for example, a diffuser, a diffusion sheet, a lens sheet and a luminance increasing sheet which are located sequentially in this order from the backlight unit 70 side. The optical members 78 are not limited to being this combination of elements or being located in this order. The case 74 is further provided with the frame 84 having a generally frame-like shape in order to hold the optical members 78 in the state where the optical members 78 are fit into the case 74.

On the rear side of the case 74, an inverter circuit substrate (not shown) on which an inverter circuit is mounted and an inverter transducer (not shown) as a booster circuit for supplying power to each of the light sources 72 are provided, but these elements do not characterize the present invention and so will not be described.

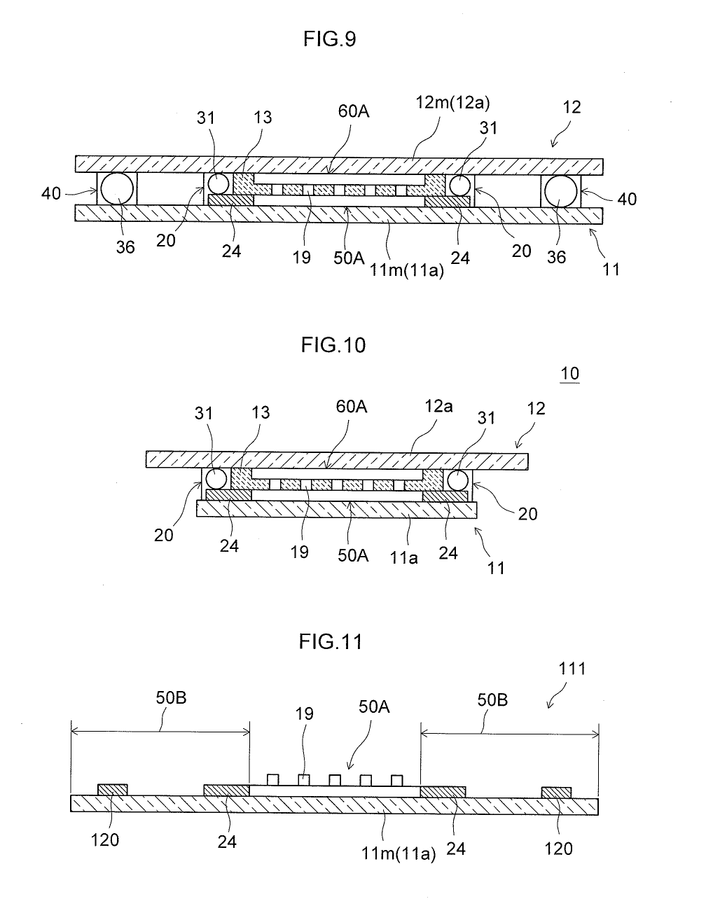

Now, with reference to FIG. 5 through FIG. 10, an example of method for producing the liquid crystal panel 10 in this embodiment will be described. FIG. 5 is a flowchart showing a method for producing the liquid crystal panel 10 in this embodiment. FIG. 6 is a cross-sectional view schematically showing a structure of the array substrate 12, and FIG. 7 is a cross-sectional view schematically showing a structure of the CF substrate 11. FIG. 8 is a cross-sectional view schematically showing the CF substrate 11 provided with the sealing material at a predetermined position. FIG. 9 is a cross-sectional view schematically showing the array substrate 12 and the CF substrate 11 which are brought together such that the array substrate-side display area 60A and the CF substrate-side display area 50A face each other. FIG. 10 is a cross-sectional view schematically showing a structure of the liquid crystal panel 10 after a cutting step.

As shown in FIG. 5 and FIG. 6, the method in this embodiment includes producing the array substrate 12 (array substrate production step S1). The method itself of producing the array substrate 12 by forming an array of TFTs 45 (see FIG. 2) on the glass substrate main body 12a (i.e., pre-cutting array mother board 12m) may be substantially the same as the conventional method. According to one preferable method, photolithography is adopted. According to this method, first, on the array mother board 12m formed of one glass plate, a metal film for gate lines (gate electrodes; not shown) is formed. On the metal film, a photosensitive agent (resist) is applied. A mask having a pattern of an electronic circuit is put thereon (mask alignment), and is irradiated with light (typically, ultraviolet light) for exposure. Then, the post-exposure mother board is developed, and etching is performed in accordance with the pattern formed by the development. Thus, the gate electrodes are formed. The source lines 42 (see FIG. 3), the transparent pixel electrodes 46 (see FIG. 3), the flattening layer 47 (see FIG. 3) and the like are sequentially formed (stacked) on the gate electrodes by repeating substantially the same steps as those for forming the gate electrodes.

Next, an alignment film material (e.g., a polyimide material) is applied on the flattening layer 47 by, for example, an inkjet method, and then a rubbing treatment (treatment of rubbing the film with, for example, a cloth in a predetermined direction) is performed for controlling the alignment direction of the liquid crystal molecules. Thus, the alignment film 49 (see FIG. 3) is formed. In this manner, the array substrate (TFT substrate) 12 having the array substrate-side display area 60A is produced (see FIG. 6). The array substrate-side non-display area 60B is formed so as to surround the array substrate-side display area 60A.

As shown in FIG. 5 and FIG. 7, the method in this embodiment includes producing the CF substrate 11 (CF substrate production step S2). The method for producing the CF substrate 11 may also be substantially the same as the conventional method. According to one preferable method, photolithography is adopted like for the array substrate 12. According to this method, first, on the glass substrate main body 11a (i.e., pre-cutting CF mother board 11m), the black matrix 22 (see FIG. 3) acting as a frame surrounding the color filters 26 (see FIG. 3) of each color is formed in a lattice by, typically, photolithography. In this step, the frame black matrix 24 is formed in the CF substrate-side non-display area 50B, such that the black matrixes 22 and 24 are integral with, and continuous to, each other.

Next, for example, an R (red) pigment-dispersed resist (resist material obtained by dispersing a red pigment in a transparent resin) is uniformly applied to the CF mother board 11m having the black matrix 22 in the CF substrate-side display area 50A formed thereon. Then, mask alignment and exposure are performed to print a pattern of the R color filters 26 (see FIG. 3). Next, development is performed to form R sub pixels (color filters) in a predetermined pattern. G (green) and B (blue) color filters 26 (see FIG. 3) are formed in substantially the same manner. Then, the flattening layer 27 (see FIG. 3) and a conductive film to be the transparent electrode 28 (see FIG. 3) are formed on the color filters 26 and the black matrix 22 by, for example, sputtering, photolithography or the like.

The method for forming the alignment film 29 (see FIG. 3) on the transparent electrode 28 may be the same as the method for forming the alignment film 49 of the array substrate 12.

In this manner, the CF substrate 11 having the CF substrate-side display area 50A is produced (see FIG. 7). Then, in order to maintain the gap between the CF substrate 11 and the array substrate 12 at a certain distance, the plurality of photospacers 19 are formed at predetermined positions in the CF substrate-side display area 50A (typically, on the black matrix 22) by photolithography or the like.

As shown in FIG. 5 and FIG. 8, the method in this embodiment includes providing (applying) the sealing material at a predetermined position of the CF substrate 11 obtained by the above-described steps (sealing material application step S3). The sealing material is applied to the CF substrate 11 by, for example, a dispenser method. In this embodiment, a panel sealing material 30 (e.g., sealing adhesive formed of light (UV)-curable resin material) is applied around the entire circumference of the frame black matrix 24 so as to overlap (typically, to be stacked on) at least a part of the frame black matrix 24 of the CF substrate 11. The panel sealing material 30 contains panel spacers (having, for example, a spherical or cylindrical shape; in this embodiment, having a spherical shape) 31 in order to uniformize the gap between the CF substrate 11 and the array substrate 12 (thickness of the liquid crystal layer 13). In this embodiment, the panel sealing material 30 is applied such that the panel spacers 31 are located on the frame black matrix 24. The grain diameter of the panel spacers 31 (in the case where the panel spacers 31 are cylindrical, the height of the panel spacers 31) is defined based on the gap between the CF substrate 11 and the array substrate 12.

An assisting sealing material 35 formed of substantially the same material as that of the panel sealing material 30 is provided at a position on the CF substrate 11 (position on an area of the CF mother board 11m which is to be the CF substrate-side non-display area 50B), the position being away from the frame black matrix 24 in the outer direction (direction of being away from the CF substrate-side display area 50A) by a predetermined distance (e.g., about 2 mm to 8 mm; in this embodiment, 5 mm). The assisting sealing material 35 may be provided to the position away from the frame black matrix 24 by the predetermined distance so as to surround the entire circumference of the frame black matrix 24, or the assisting sealing material 35 may be provided at a position away from a specific position of the frame black matrix 24 by the predetermined distance. Preferably, the assisting sealing material 35 is applied so as to surround the entire circumference of the frame black matrix 24.

The assisting sealing material 35 contains assisting spacers (having, for example, a spherical or cylindrical shape; in this embodiment, having a spherical shape) 36 in order to uniformize the gap between the CF substrate 11 and the array substrate 12 (thickness of the liquid crystal layer 13). In this embodiment, in order to prevent both of the CF substrate 11 and the array substrate 12, when these substrates are brought together as described later, from being bent between the panel sealing portion 20 obtained by curing the panel sealing material 30 and an assisting sealing portion 40 obtained by curing the assisting sealing material 35, the assisting spacers 36 are used as a bending prevention member at the positions where the assisting sealing portion 40 is to be formed (i.e., in the assisting sealing material 35) (see FIG. 9).

The assisting spacers 36 as the bending prevention member have a larger grain diameter than that of the panel spacers 31 because the panel spacers 31 are located on the frame black matrix 24. Namely, spacers having the same grain diameter as the height of the panel sealing portion 20 (i.e., the sum of the grain diameter of the panel spacers 31 and the thickness of the frame black matrix 24 in the part where the panel spacers 31 are stacked on the frame black matrix 24) are used as the assisting spacers 36. Such an arrangement is adopted so that when the CF substrate 11 and the array substrate 12 are brought together as described later, the gap between the CF substrate 11 and the array substrate 12 (specifically, the interval between the CF mother board 11m and the array mother board 12m, namely, the interval between the post-cutting substrate main body 11a and the post-cutting substrate main body 11b is maintained at a predetermined distance in an area in the vicinity of the panel sealing portion 20. The assisting sealing material 35 may be applied to a position of the array substrate 12, the position corresponding to the position which is away by the predetermined distance from the frame black matrix 24 of the CF substrate 11.

Next, the liquid crystal material is injected by the dispenser method into a part surrounded by the panel sealing material 30 on the CF substrate 11, or a part on the array substrate 12 corresponding to the part surrounded by the panel sealing material 30 on the CF substrate 11. As shown in FIG. 5 and FIG. 9, the method in this embodiment includes bringing together the CF substrate 11 and the array substrate 12 in a vacuum environment such that the display areas 50A and 60A overlap each other (bringing-together step S4). By bringing together the CF substrate 11 and the array substrate 12, the liquid crystal layer 13 is formed between the CF substrate 11 and the array substrate 12 as shown in FIG. 9.

The pair of substrates 11 and 12 which are brought together are released from the vacuum environment and returned to an atmospheric pressure atmosphere, so that the surfaces of the CF substrate 11 and the array substrate 12 are pressurized. The panel sealing material 30 and the assisting sealing material 35 are irradiated with light (e.g., ultraviolet light) to be cured (provisional curing of seal), and then are heated. Thus, the curing of the panel sealing material 30 and the assisting sealing material 35 is completed, and the panel sealing portion 20 and the assisting sealing portion 40 are formed (see FIG. 9). Since the assisting sealing portion 40 contains the assisting spacers 36 as the bending prevention member, the height of the part where the panel sealing portion 20 is formed is equal to the height of the part where the assisting sealing portion 40 is formed. Therefore, neither the CF substrate 11 nor the array substrate 12 is bent between the part where the panel sealing portion 20 is formed and the part where the assisting sealing portion 40 is formed. Owing to this, the space (gap) between the CF substrate 11 and the array substrate 12 can be prevented from becoming non-uniform.

As shown in FIG. 5 and FIG. 10, the method in this embodiment includes cutting the CF substrate 11 and the array substrate 12 which are brought together into a predetermined size (cutting step S5). Namely, the CF mother board 11m and the array mother board 12m are cut along a cutting part 11c of the CF mother board 11m and a cutting part 12c of the array mother board 12m (the part represented by the one-dot chain line in FIG. 4 is cut away). As a result, the liquid crystal panel 10 including the substrate main body 11a and the substrate main body 12a having a predetermined size is obtained. The method for cutting the substrates 11 and 12 may be substantially the same as the conventional cutting method, and may be, for example, a method of scratching cutting lines and cracking the substrates along the scratched lines, a method of cutting the substrates by laser radiation or the like.

In this manner, the liquid crystal panel 10 is completed (see FIG. 10). According to the method in this embodiment, the CF substrate 11 and the array substrate 12 can be prevented from being bent and thus the cell thickness of the liquid crystal panel 10 can be made uniform. Therefore, the liquid crystal panel 10 in which a defect such as a light leak from the backlight unit is suppressed can be produced.

In the above embodiment, as the bending prevention member, the assisting spacers 36 having a larger grain diameter than that of the panel spacers 31 are provided in the part where the assisting sealing portion 40 is to be formed. The present invention is not limited to such an embodiment. Hereinafter, a method for producing a liquid crystal panel according to

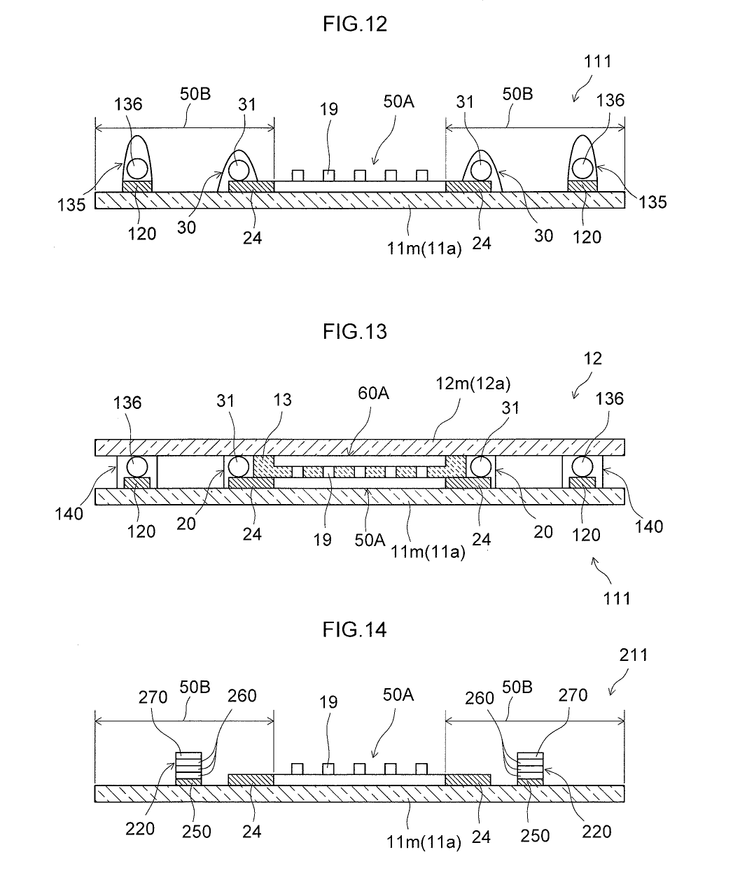

Embodiment 2 will be described with reference to the drawings. FIG. 11 is a cross-sectional view schematically showing a structure of a CF substrate 111. FIG. 12 is a cross-sectional view schematically showing the CF substrate 111 provided with a sealing material at a predetermined position. FIG. 13 is a cross-sectional view schematically showing the array substrate 12 and the

CF substrate 111 which are brought together such that the array substrate-side display area 60A and the CF substrate-side display area 50A face each other.

As shown in FIG. 11, the method in this embodiment includes producing the CF substrate 111 (corresponding to the CF substrate production step S2 shown in FIG. 5). The CF substrate 111 is produced in substantially the same manner as the CF substrate 11 in Embodiment 1. The CF substrate-side display area 50A is formed on the CF mother board 11m, and the frame black matrix 24 is formed so as to surround the CF substrate-side display area 50A. A black matrix 120 as a base part of a bending prevention member is formed at a position on the CF mother board 11m, the position being away from the frame black matrix 24 in the outer direction by a predetermined distance (e.g., about 2 mm to 8 mm; in this embodiment, 6 mm). The black matrix 120 may be formed on the CF mother board 11m by photolithography, for example, at the same time as the black matrix 22 in the CF substrate-side display area 50A and the frame black matrix 24 of the CF substrate 111. The base part is not limited to being formed of a material used to form the black matrixes 22, 24 and 120, and may be formed of a material used to form the color filters (colored layers) or a material used to form the photospacers 19. Alternatively, the base part may be formed by stacking these materials. The base part may be formed at the same time as the CF substrate-side display area 50A of the CF substrate 111, and it is not necessary to add a new step for forming the base part. It is preferable that the base part 120 is formed to have the same height as that of the frame black matrix 24. Since the base part 120 is formed in this manner, spacers having the same grain diameter as that of the panel spacers 31 contained in the panel sealing material 30 can be used as assisting spacers 136 to be contained in an assisting sealing material 135 described later.

As shown in FIG. 12, the method in this embodiment includes providing (applying) the sealing material at a predetermined position of the CF substrate 111 obtained by the above-described steps (corresponding to the sealing material application step S3 shown in FIG. 5). Like in Embodiment 1, the panel sealing material 30 is applied around the entire circumference of the frame black matrix 24 so as to overlap at least a part of the frame black matrix 24. In addition, the assisting sealing material 135 is applied to the black matrix 120 as the base part.

The grain diameter of the assisting spacers 136 contained in the assisting sealing material 135 is defined based on the gap between the CF substrate 111 and the array substrate 12 and the height of the base part 120. In the case where the frame black matrix 24 and the black matrix 120 have the same height (from the substrate main body 11m), spacers having the same grain diameter as that of the panel spacers 31 can be used as the assisting spacers 136. Namely, it is preferable that the assisting spacers 136 have a grain diameter with which the panel sealing portion 20 obtained by curing the panel sealing material 30 and an assisting sealing portion 140 obtained by curing the assisting sealing material 135 have the same height.

Next, like in Embodiment 1, the method in this embodiment includes injecting the liquid crystal material and bringing together the CF substrate 111 and the array substrate 12 in a vacuum environment such that the display areas 50A and 60A overlap each other (corresponding to the bringing-together step S4 shown in FIG. 5). The pair of substrates 111 and 12 which are brought together are released from the vacuum environment and returned to an atmospheric pressure atmosphere, so that the surfaces of the CF substrate 111 and the array substrate 12 are pressurized. The panel sealing material 30 and the assisting sealing material 135 are irradiated with light (e.g., ultraviolet light) to be cured (provisional curing of seal), and then are heated. Thus, the curing of the panel sealing material 30 and the assisting sealing material 135 is completed, and the panel sealing portion 20 and the assisting sealing portion 140 are formed (see

FIG. 13). In this embodiment, the black matrix (base part) 120 is formed as a bending prevention member having the same height as the frame black matrix 24, in the part where the assisting sealing portion 140 is to be foamed (a stacked structure in which the assisting sealing portion 140 is stacked on the black matrix 120 is provided), and the assisting sealing portion 140 contains the assisting spacers 136 having the same grain diameter as that of the panel spacers 31.

Therefore, the height of the part where the panel sealing portion 20 is formed is equal to the height of the part where the assisting sealing portion 140 is formed. Thus, neither the CF substrate 111 nor the array substrate 12 is bent between the part where the panel sealing portion 20 is formed and the part where the assisting sealing portion 140 is formed. Owing to this, the space (gap) between the CF substrate 111 and the array substrate 12 can be prevented from becoming non-uniform.

Next, the CF substrate 111 and the array substrate 12 which are brought together are cut into a predetermined size, and thus a liquid crystal panel which is substantially the same as the liquid crystal panel 10 in Embodiment 1 is completed. As described above, according to the method for producing the liquid crystal panel 10 in this embodiment, the CF substrate 111 and the array substrate 12 can be prevented from being bent and thus the cell thickness of the liquid crystal panel 10 can be made uniform. Therefore, the liquid crystal panel 10 in which a defect such as a light leak from the backlight unit is suppressed can be produced.

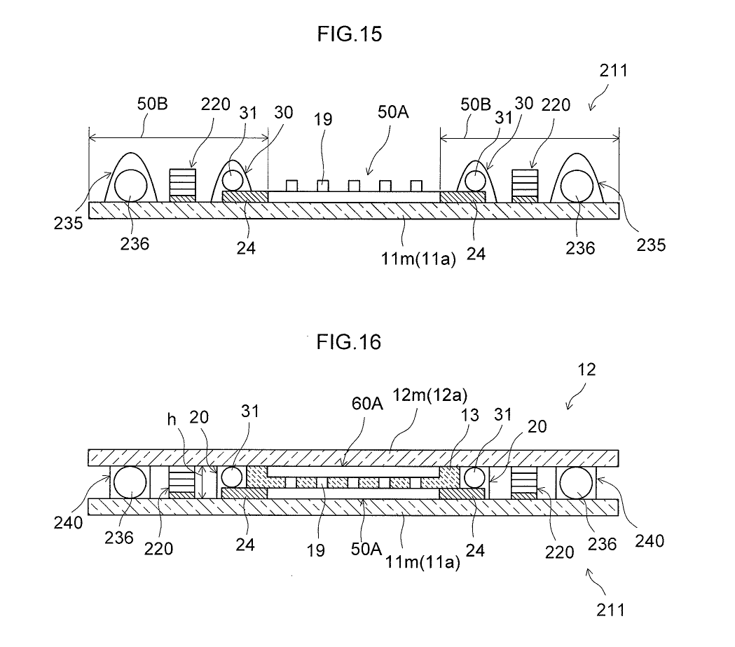

In the various embodiments described above, the bending prevention member is provided in the part where the assisting sealing portion 40 or 140 is to be formed. The present invention is not limited to such an embodiment. Hereinafter, a method for producing a liquid crystal panel according to Embodiment 3 will be described with reference to the drawings. FIG. 14 is a cross-sectional view schematically showing a structure of a CF substrate 211. FIG. 15 is a cross-sectional view schematically showing the CF substrate 211 provided with a sealing material at a predetermined position. FIG. 16 is a cross-sectional view schematically showing the array substrate 12 and the CF substrate 211 which are brought together such that the display areas 60A and 50A face each other.

As shown in FIG. 14, the method in this embodiment includes producing the CF substrate 211 (corresponding to the CF substrate production step S2 shown in FIG. 5). The CF substrate 211 is produced in substantially the same manner as the CF substrate 11 in Embodiment 1. The CF substrate-side display area 50A is formed on the glass substrate main body 11a (i.e., pre-cutting CF mother board 11m), and the frame black matrix 24 is formed so as to surround the CF substrate-side display area 50A. A column-like member 220 as a bending prevention member is formed at a position away from the frame black matrix 24 in the outer direction by a predetermined distance (e.g., about 2 mm to 8 mm; in this embodiment, 3 mm) (on a position of the CF mother board 11m, the position being between the position to which the panel sealing material 30 is to be applied and the position to which an assisting sealing material 235 is to be applied). The column-like member 220 includes a black matrix layer 250 formed of a material used to form the black matrixes 22 and 24, a colored layer 260 formed of a material used to form the color filters (colored layers) 26, and a photospacer layer 270 formed of a material used to form the photospacers 19. The height of the column-like member 220 is defined based on the gap between the CF substrate 211 and the array substrate 12. In this embodiment, the column-like member 220 is formed to have the same height as that of the panel sealing portion 20 (“h” in FIG. 16; the sum of the height of the frame black matrix 24 and the height of the panel spacers 31).

In this embodiment, the column-like member 220 includes a plurality of layers.

Alternatively, the column-like member 220 may be formed of any one of the materials of, or a combination of at least two of the materials of, the plurality of layers. The column-like member 220 may be formed at the same time as the display area 50A of the CF substrate 211, and it is not necessary to add a new step for forming the column-like member. The height (thickness) of the column-like member 220 can be easily determined by adjusting the amount of the material applied to form the column-like member.

As shown in FIG. 15, the method in this embodiment includes providing (applying) the sealing material at a predetermined position of the CF substrate 211 (corresponding to the sealing material application step S3 shown in FIG. 5). Like in Embodiment 1, the panel sealing material 30 is applied around the entire circumference of the frame black matrix 24 so as to overlap at least a part of the frame black matrix 24. In addition, the assisting sealing material 235 is applied to a position (on the CF mother board 11m) which is away from the frame black matrix 24 in the outer direction by a predetermined distance. There is no specific limitation on the grain diameter of assisting spacers 236 contained in the assisting sealing material 235 as long as the grain diameter is equal to or less than the height of the column-like member 220. It is preferable that the grain diameter of assisting spacers 236 is equal to the height of the column-like member 220 (from the CF mother board 11m).

Next, like in Embodiment 1, the method in this embodiment includes injecting the liquid crystal material and bringing together the CF substrate 211 and the array substrate 12 in a vacuum environment such that the display areas 50A and 60A overlap each other (corresponding to the bringing-together step S4 shown in FIG. 5). The pair of substrates 211 and 12 which are brought together are released from the vacuum environment and returned to an atmospheric pressure atmosphere, so that the surfaces of the CF substrate 211 and the array substrate 12 are pressurized. The panel sealing material 30 and the assisting sealing material 235 are irradiated with light (e.g., ultraviolet light) to be cured (provisional curing of seal), and then are heated. Thus, the curing of the panel sealing material 30 and the assisting sealing material 235 is completed, and the panel sealing portion 20 and an assisting sealing portion 240 are formed (see FIG. 16). Since the column-like member 220 is formed as a bending prevention member between the panel sealing portion 20 and the assisting sealing portion 240, the CF substrate 211 and the array substrate 12 can be effectively prevented from being bent between the panel sealing portion 20 and the assisting sealing portion 240. Owing to this, the space (gap) between the CF substrate 211 and the array substrate 12 can be prevented from becoming non-uniform.

Next, the CF substrate 211 and the array substrate 12 which are brought together are cut into a predetermined size, and thus a liquid crystal panel which is substantially the same as the liquid crystal panel 10 in Embodiment 1 is completed. As described above, according to the method for producing the liquid crystal panel 10 in this embodiment, the CF substrate 211 and the array substrate 12 can be prevented from being bent and thus the cell thickness of the liquid crystal panel 10 can be made uniform. Therefore, the liquid crystal panel 10 in which a defect such as a light leak from the backlight unit is suppressed can be produced.

On the front side (i.e., the CF substrate 11 side) and on the rear side (the array substrate 12 side) of the liquid crystal panel 10 completed as described above, the bezel 82 and the frame 84 are respectively located to support the liquid crystal panel 10. On the rear side of the frame 84, the optical members 78 and the backlight unit 70 accommodated in the case 74 are mounted. Thus, the liquid crystal display device 100 is constructed.

So far, the present invention has been described by way of preferable embodiments. These descriptions do not limit the present invention, and the present invention may be modified in various manners, needless to say.

According to a method for producing a liquid crystal panel provided by the present invention, a bending prevention member for preventing bending is provided in a part where an assisting sealing portion is to be formed and/or a part between the assisting sealing portion and a panel sealing portion. Therefore, when the liquid crystal display device is constructed, a pair of substrates (typically, an array substrate and a CF substrate) facing each other while having a liquid crystal layer therebetween are prevented from being bent and thus the cell thickness of the liquid crystal panel can be made uniform.

By use of such a liquid crystal panel, a high quality liquid crystal display device in which a defect such as a light leak or the like is suppressed can be easily realized.

1. A method for producing a liquid crystal panel, the liquid crystal panel including:
a pair of substrates facing each other;
a liquid crystal layer formed between the pair of substrates; and
a panel sealing portion located around the liquid crystal layer between the pair of substrates so as to surround the liquid crystal layer to hold the liquid crystal layer between the pair of substrates,
the method comprising:
preparing a first substrate and a second substrate acting as the pair of substrates, wherein a black matrix, for blocking external light from entering an area where the liquid crystal layer is to be formed, is formed at a surface of the first substrate facing the liquid crystal layer, in a peripheral area outer to the area where the liquid crystal layer is to be formed; a panel sealing material which is to form the panel sealing portion is provided so as to overlap at least a part of the black matrix; and an assisting sealing material which is to form an assisting sealing portion is provided on either the first substrate or the second substrate, at a position which is away from the black matrix in an outer direction by a predetermined distance;
bringing together the first substrate and the second substrate to form the panel sealing portion formed of the panel sealing material and the assisting sealing portion formed of the assisting sealing material; and
supplying a liquid crystal material before or after bringing together the first substrate and the second substrate to form the liquid crystal layer between the pair of substrates;
wherein a bending prevention member for preventing bending is provided in a part where the assisting sealing portion is formed and/or a part between the assisting sealing portion and the panel sealing portion, in order to prevent the pair of substrates from being bent between the panel sealing portion and the assisting sealing portion when the pair of substrates are brought together.
wherein in the part between the panel sealing portion and the assisting sealing portion, a column-like member for holding the gap between the substrates in the part is formed as the bending prevention member.

2. The method according to claim 1, wherein:
the panel sealing material and the assisting sealing material each include granular spacers for holding a gap between the pair of substrates; and
the spacers in the assisting sealing material are contained as the bending prevention member and have a larger grain diameter than that of the spacers contained in the panel sealing material.

3. The method according to claim 1, wherein in the part where the assisting sealing portion is formed, a base part, on which the assisting sealing material which is to form the assisting sealing portion is stacked, is formed as the bending prevention member in either one of the pair of substrates, and the assisting sealing portion is formed in state of being stacked on the base part.

4. The method according to claim 3, wherein the base part is formed by use of at least one of a black matrix formation material, a colored layer formation material, and a photospacer formation material.

5. (canceled)

6. The method according to claim 1, wherein the column-like member is formed by use of at least one of a black matrix formation material, a colored layer formation material, and a photospacer formation material.

7. A method for producing a liquid crystal display device which comprising a pair of substrates facing each other; a liquid crystal layer formed between the pair of substrates; a panel sealing portion located around the liquid crystal layer between the pair of substrates so as to surround the liquid crystal layer to hold the liquid crystal layer between the pair of substrates; and a liquid crystal panel being held by a predetermined frame member;
the method comprising a process for producing the liquid crystal panel,
the process for producing the liquid crystal panel comprising:
preparing a first substrate and a second substrate acting as the pair of substrates, wherein a black matrix, for blocking external light from entering an area where the liquid crystal layer is to be foamed, is formed at a surface of the first substrate facing the liquid crystal layer, in a peripheral area outer to the area where the liquid crystal layer is to be formed; a panel sealing material which is to form the panel sealing portion is provided so as to overlap at least a part of the black matrix; and an assisting sealing material which is to form an assisting sealing portion is provided on either the first substrate or the second substrate, at a position which is away from the black matrix in an outer direction by a predetermined distance;
bringing together the first substrate and the second substrate to form the panel sealing portion formed of the panel sealing material and the assisting sealing portion formed of the assisting sealing material; and
supplying a liquid crystal material before or after bringing together the first substrate and the second substrate to form the liquid crystal layer between the pair of substrates;
wherein a bending prevention member for preventing bending is provided in a part where the assisting sealing portion is formed and/or a part between the assisting sealing portion and the panel sealing portion, in order to prevent the pair of substrates from being bent between the panel sealing portion and the assisting sealing portion when the pair of substrates are brought together,
wherein in the part between the panel sealing portion and the assisting sealing portion, a column-like member for holding the gap between the substrates in the part is formed as the bending prevention member.
